(19) United States
(12) Patent Application Publication
(10) Pub. No.: US 2013/0178959 A1
(43) Pub. Date: Jul. 11, 2013

(54) Method and System for Predicting and Measuring Event Durations and Operating Related Contests

(71) Applicant: Gary Hirsch, Wilton, CT (US)

(72) Inventor: Gary Hirsch, Wilton, CT (US)

(21) Appl. No.: 13/738,577

(22) Filed: Jan. 10, 2013

Related U.S. Application Data
(60) Provisional application No. 61/585,398, filed on Jan. 11, 2012.

(51) Int. Cl. G06F 19/00

(52) U.S. Cl. CPC G06F 19/00
USPC 700/91

(57) ABSTRACT

The present invention allows event participants to predict the duration of an event before it begins, monitor the event duration, establish and record the official event duration and compare the official event duration to the participants' predictions. In the preferred embodiment of the invention, users employ a computer or mobile device interface to predict, monitor and establish the duration of a business meeting or conference call and compete to earn rewards based on the accuracy of their respective predictions and from other meeting participants.

### CROSS-REFERENCE TO RELATED DOCUMENTS

The present patent application is a non-provisional application of provisional application 61/585,398, filed Jan. 11, 2012 and entitled “Method And System For Predicting And Measuring Event Durations And Operating Related Contests”, disclosure of which is incorporated herein in entirety at least by its reference.

### BACKGROUND

1. Field of The Invention

The invention relates to an interactive computer-based method and system for predicting, monitoring and establishing the duration of real-world events such as business meetings and conference calls and for operating contests relating to such event durations and the behavior of participants.

2. BACKGROUND OF THE INVENTION

Real world events can be timed using clocks and timers, such as a timer on a scoreboard or a clock on a wall, which can be observed by persons in the same physical location. A digital or analog clock face also can be displayed to observers of an event through various media by means of a video or digital broadcast. However, if an official timer is not maintained and transmitted by the event organizer, persons observing or participating in an event from remote locations lack a convenient means to collectively keep the time of the event. Individuals can access or download electronic timers through the Internet to monitor the duration of an event. However, such timers do not allow multiple event participants to share control of the timer. In the gaming area, online game timers and clocks measure the duration of events occurring within the game itself, as opposed to external real-life events. There is a need to facilitate the timing of real world events using a computer interface shared among participants or observers of each event.

Certain events, such as racing events, are timed best by using a single official mechanism over which the event participants have no control, such as a race clock. Certain other events either cannot be timed by a single independent time keeper or may be desired to be timed only by a subset of event participants or observers. Timing events in those cases requires a consensus or establishment of an official time according to rules agreed among the event participants. There is a need for an online timing mechanism that allows the duration of an offline event to be measured according to participant consensus or other rules.

Business meetings, video conferences, teleconferences, online demonstrations, slide presentations and web conferences are examples of events that occur in large numbers every day around the world. The time spent by millions of people each day in these meetings is a topic of great concern to anyone who understands that “time is money”. Certain professionals such as lawyers and consultants are paid by the hour and track the time they spend in every meeting. For clients of these professionals, as well as the innumerable corporate workers called to meetings on a daily and hourly basis, meeting durations are often unpredictable and hard to control. Meeting leaders fail to establish meeting durations in advance, fail to control the meeting time or disregard pre-established meeting schedules. Generally, meetings suffer from low participant satisfaction and engagement. They are notoriously boring, resulting in counterproductive behaviors by participants such as playing online games, instant messaging or engaging in offline activities that distract participants from the subject matter of the meeting. Meeting participants often lack motivation or confidence to control the meeting duration, even when they have legitimate arguments for extending or ending a meeting. Many hours and dollars are spent on tools, technology, consultants, training and other resources to combat these problems and improve the efficiency and productivity of meetings, as well as employee engagement and satisfaction.

The application of gaming and game theory (also known as gamification) to business and commercial activities is a growing trend. Companies find that using game principles in training, customer service, innovation and other business functions enhances employee engagement and quality of results. Gamification is effective when it enhances engagement by introducing an element of competition and fun for participants, without undermining the activity's business objectives.

Effective gamification (i.e. enhancement of participation without jeopardizing business objectives) of meetings could be accomplished by providing a unique means for meeting participants to collectively measure the duration of a meeting, compare the actual duration to each participant's duration prediction and reward those participants whose predictions come closest to the actual meeting duration. Such game or contest based on the accuracy of individual predictions of the duration of an event engenders greater attention to the event by invoking competition among participants and observers. The “social loafing” that occurs in meetings would be expected to diminish. Enhancing engagement would be expected to help break group paralysis and laziness. The competition, being limited to predicting and influencing event duration, would not be so intense as to hinder or adversely affect participant relationships or event objectives. Rather, a competition of this nature would distract participants from more insidious personal issues that could impair group dynamics and would channel competitive urges to relatively innocuous behavior. In addition, participants may perceive a greater degree of individual influence over and satisfaction with the results of the event based on their ability to influence the event duration. Indeed, a computer interface for monitoring the duration of a meeting for this purpose also could be used to facilitate communication and cooperation among meeting participants, including a means for participants to form alliances or reward one another for certain types of behavior.

Collectively predicting an event's duration can be expected to affect the actual event duration in ways that will vary based on the participants and subject matter of each event. For example, for certain events, predictions may produce an unspoken consensus regarding how long the event should take, and game dynamics may yield actual event durations approaching the mean of duration predictions. Providers of online meeting platforms, consultants and event organizers could compare historical event durations to duration predictions in order to improve event scheduling and participant satisfaction by making event durations more consistent with participant expectations.

Thus, persons participating in meetings of all kinds as well as their employers, business partners and vendors, could benefit from a game based on predicting a meeting's duration and a means for monitoring and establishing an official meeting duration through a shared interface.

### SUMMARY OF THE INVENTION

The present invention allows participants and observers of real-world events to predict the duration of an event before it begins, monitor the event duration, establish and record the official event duration and compare the official event duration to the participants' predictions. In the preferred embodiment of the invention, users employ a computer or mobile device interface to predict, monitor and establish the duration of a business meeting or conference call and compete to earn points or other rewards based on the accuracy of their respective predictions. Users also may grant rewards to one another during the course of the meeting or conference call, at their discretion or based on user behaviors matching certain pre-defined criteria.

The preferred embodiment of the invention is an Internet based, multi-user game. The principal advantage of the invention is that it engenders friendly competition and enhanced engagement in an event whose duration can be influenced by the event participants. It accomplishes this by providing a method and system for recording duration predictions, measuring event durations in real time, establishing an official, actual event duration and comparing the actual duration to participants' predictions, all within a session-specific online interface.

The arrival of the Internet has made possible a new, highly social genre of computer-video games wherein users remotely located can view and interact with shared session-specific interfaces. This construct permits thousands to literally unlimited numbers of players to participate in as many unique game sessions simultaneously. The technology used for conducting conference calls, web meetings and other electronic and virtual gatherings has evolved similarly to allow millions of private meeting sessions to be conducted simultaneously on any one of numerous competing Internet based platforms such as WebEx, GoToMeeting.com and dozens of similar services. Those services, to significant extent, have not yet integrated or marketed multi-player games designed to enhance meeting participation, but such endeavors are likely to emerge as gamification of business processes becomes more popular. Allowing users of such platforms to compete in games involving the time-keeping of meetings and individual influence on meeting duration and dynamics would make meetings more enjoyable and engaging, and make the platforms themselves therefore more attractive to users.

BRIEF DESCRIPTION OF THE DRAWING FIGURES

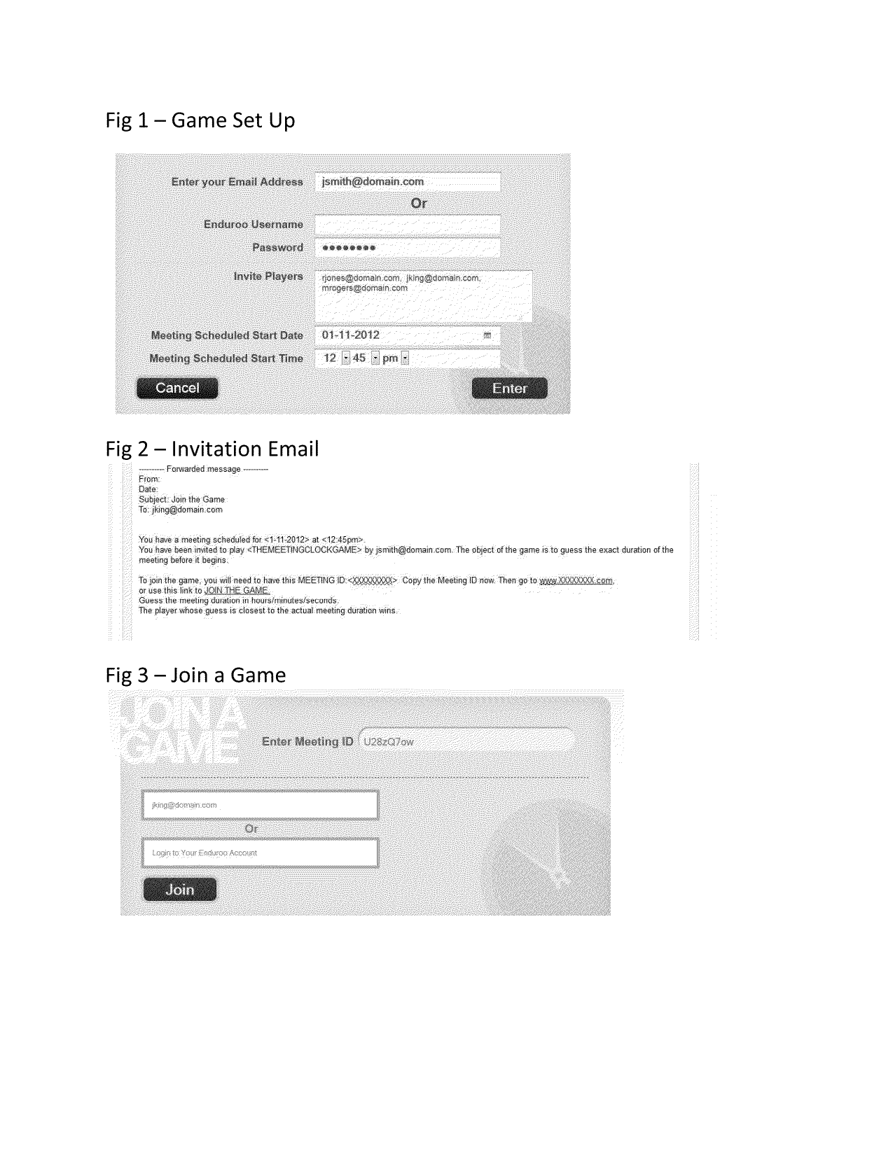

FIG. 1 is an example of a game setup interface in an embodiment of the invention.

FIG. 2 is an example of an invitation email in an embodiment of the invention.

FIG. 3 is an example of an interactive interface for joining a game in an embodiment of the invention.

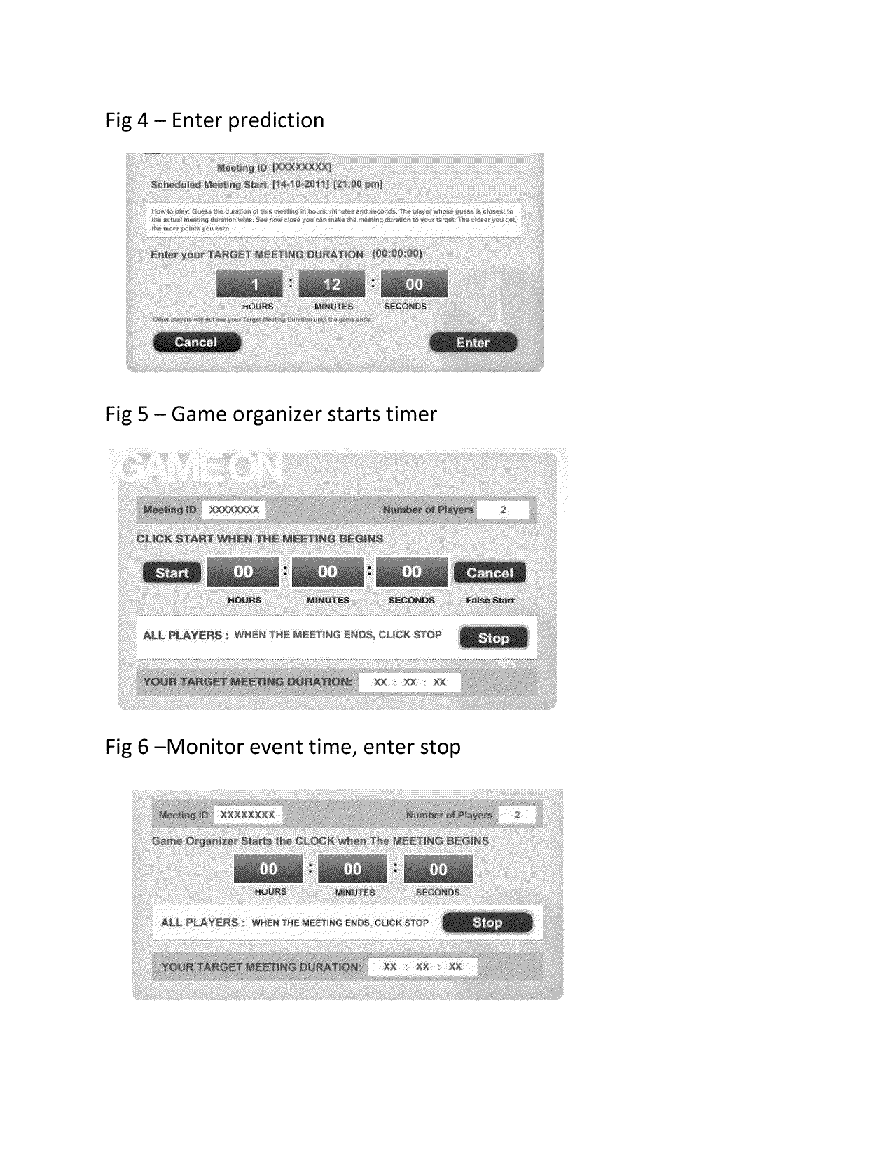

FIG. 4 is an example of an interface or entering a prediction in an embodiment of the invention.

FIG. 5 is an example of an interface allowing an organizer to start a timer in an embodiment of the invention.

FIG. 6 is an example of an interface for displaying time monitored in an embodiment of the invention.

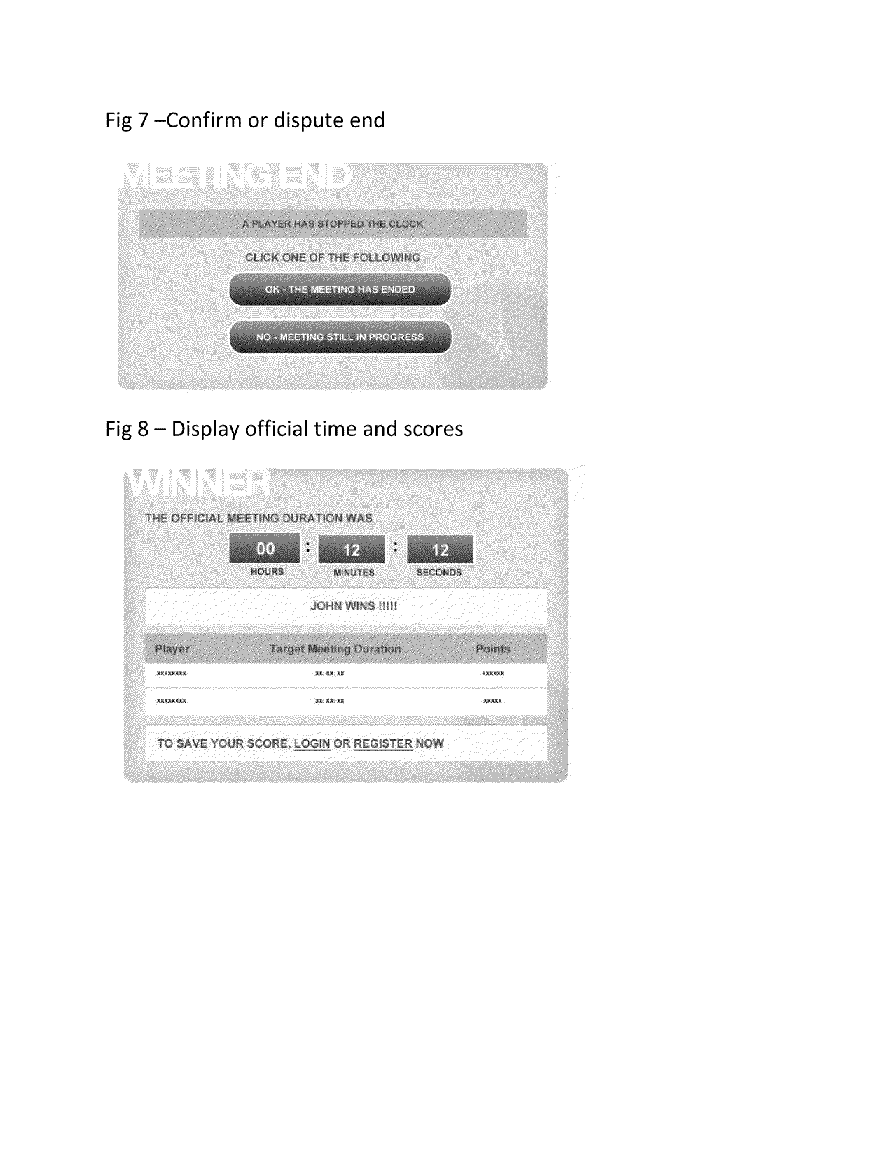

FIG. 7 is an example of an interface for confirming or disputing and end to a game in an embodiment of the invention.

FIG. 8 is an example of an interface displaying official times and scores in an embodiment of the invention.

### DETAILED DESCRIPTION OF THE PREFERRED EMBODIMENT OF THE INVENTION

The attached figures illustrate the preferred embodiment of the invention, which would operate as follows:
a. A person (game organizer) invited to an event (meeting) may initiate a game session by entering into a computer interface certain data regarding the event (such as meeting date, time, subject) and the email address or other identifiers of one or more other persons to be invited to play during the event (participants). See FIG. 1. This information is transmitted to a server which returns a unique game session ID (consisting of letters and number characters for example).
b. An email or other communication such as text (SMS) message, which may include a link to the game interface, is issued to the participants. See FIG. 2.
c. Each participant may join the game session by entering the session ID and his email address or other identifier through the computer interface. See FIG. 3. In a further embodiment of the invention not depicted in the figures, the subject matter of each event may be required to be entered by the game organizer or at least one participant in order to analyze the impact of the use of the invention on the conduct of specific types of events.
d. The participants and the game organizer (together, users) enter their respective predictions regarding the event duration. See FIG. 4. In one embodiment of the invention, the predicted event duration and official event duration (see paragraph h) are expressed in digits, to wit 00:00:00, indicating hours, minutes and seconds. After their predictions are entered through the computer interface, users are directed to a screen showing the event timer.
e. At the commencement of the event, the game organizer may start the event timer by executing a start button on the interface. See FIG. 5. The event timer may be reset by the game organizer in case of a false start.
f. The participants and the game organizer may monitor the event timer which measures the duration of the event in real time. The interface may include features to facilitate communication among users, including the ability to send and receive electronic messages or grant points or other rewards to other users, while the event timer is running. At such time that the event ends, any user may stop the event timer by executing a stop button on the interface. See FIG. 6. A stop instruction by any user is transmitted to the server which directs all users to a screen that requests the users to confirm or dispute that the event has ended by executing the appropriate button on the interface. See FIG. 7.
g. The responses of users are returned to the server, recorded and tabulated according to rules governing the conditions upon which the official event duration is established. In the initial embodiment of the invention, the official event duration is established if at least one user, other than the user who entered the stop instruction, confirms the event has ended and a majority of the other users do not dispute the stop instruction. Other rules and system improvements would be implemented to facilitate determination of accurate and agreeable measures of actual event duration.
h. Depending on the responses of the users and according to the rules in place, either an official event duration is recorded in the server (stop instruction has been confirmed), or the event timer is restored to the screen showing that the timer has continued without interruption (stop instruction has been overruled). After the official event duration is recorded, it is transmitted from the server and displayed to users. See FIG. 8. Users' individual duration predictions also are then revealed within the interface along with the scores, points or other rewards earned by users according to pre-established scoring rules. The scoring system may be based on the degree of accuracy of each user's prediction (e.g., the closer each prediction is to the actual event duration, the more points the user receives) as well as the number of users in the session.
i. In the preferred embodiment of the invention, it may be accessed and used through web browsers or mobile device applications, and the interface is configured for use on various device screens including but not limited to stand-alone monitors, laptop computers, tablets and mobile device screens.
j. In a further embodiment of the invention not depicted in the figures, an instant messaging module may be displayed with the event timer, permitting users to communicate with one another while the event timer is running. In another embodiment, users may be permitted, at their discretion or based on user behaviors matching certain pre-defined criteria, to grant points or other rewards to other users through the interface. In a further embodiment of the invention, users may be permitted to use points or rewards to order or purchase or receive virtual or physical goods or services through the user interface.

While the invention has been described with reference to specific embodiments thereof, it will be appreciated that numerous variations, modifications, and embodiments are possible, and accordingly, all such variations, modifications, and embodiments are to be regarded within the spirit and scope of the invention.

We claim:

1. A method for predicting and measuring the duration of an event wherein: (a) two or more event participants use computers or mobile devices connected to a network to enter a predicted event duration; (b) a user interface including an event timer is displayed to all participants; (c) one participant starts the timer through the user interface; (d) at any time after the timer starts, any participant may enter a provisional stop command through the user interface; (e) the stop command must be accepted through the user interface by at least one other participant; and (f) upon acceptance through the user interface of the stop command by one or more other participants, the official event duration is recorded and displayed through the user interface to all participants.

2. The method described in claim 1 wherein at least one of the participants is invited electronically to join a contest to predict the event duration and the participant whose predicted event duration is closest to the official event duration is declared through the user interface to be the winner of the contest.

3. The method described in claim 1 wherein the event is a business meeting, web meeting, online meeting, demonstration, presentation, teleconference or conference call.

4. The method described in claim 1 wherein the predicted event duration and official event duration are expressed in digits, to wit 00:00:00, indicating hours, minutes and seconds.

5. The method described in claim 1 wherein each participant's predicted event duration is displayed with the official event duration.

6. The method described in claim 1 wherein a plurality of events are conducted and timed simultaneously.

7. The method described in claim 2 wherein the invitation to join the contest is sent by email or text (SMS) message.

8. The method described in claim 7 wherein the issued message includes a link to a website or event identifier with which each participant may join the contest.

9. The method described in claim 1 wherein the participant that starts the timer can cancel such action and return the timer to zero.

10. A system for predicting and measuring the duration of an event, such system comprising: (a) two or more computing devices connected to a network; (b) a computer software program for generating a user interface capable of being displayed on such devices through the network; (c) the program and interface being configured to: (i) allow two or more users to enter a predicted event duration; (ii) display an event timer to all users; (iii) permit one user to start the timer; (iv) at any time after the timer starts, permit any user to enter a provisional stop command; and (v) upon acceptance through the user interface of the stop command by one or more other users, to record and display the official event duration through the user interface to all users.

11. The system described in claim 10 wherein at least one of the users is invited electronically to join a contest to predict the event duration and the user whose predicted event duration is closest to the official event duration is declared through the user interface to be the winner of the contest.

12. The system described in claim 10 wherein the event is a business meeting, web meeting, online meeting, demonstration, presentation, teleconference or conference call.

13. The system described in claim 10 wherein the predicted event duration and official event duration are expressed in digits, to wit 00:00:00, indicating hours, minutes and seconds.

14. The system described in claim 10 wherein each user's predicted event duration is displayed with the official event duration.

15. The system described in claim 10 wherein a plurality of events are conducted and timed simultaneously.

16. The system described in claim 11 wherein the invitation to join the contest is sent by email or text (SMS) message.

17. The system described in claim 16 wherein the issued message includes a link to a website or event identifier with which each user may join the contest.

18. The system described in claim 10 wherein the user that starts the timer can cancel such action and return the timer to zero.

19. The system described in claim 10 wherein an instant messaging module is displayed with the event timer, permitting users to communicate with one another while the event timer is running.

20. The system described in claim 11 wherein a scoring system assigns points to predicted event durations after the official event duration is determined, which points are displayed to users, wherein the scoring system is based on the relative accuracy of each predicted event duration.
